(19) United States
(12) Patent Application Publication
(10) Pub. No.: US 2022/0400200 A1
(43) Pub. Date: Dec. 15, 2022

(54) SHUTTER ACTIVATIONS

(71) Applicant: Hewlett-Packard Development Company, L.P., Spring, TX (US)

(72) Inventors: Isaac Lagnado, Houston, TX (US); King Sui Kei, Houston, TX (US); Nick Thamma, Houston, TX (US); Christopher Allan Steven, Spring, TX (US)

(21) Appl. No.: 17/347,260

(22) Filed: Jun. 14, 2021

(51) Int. Cl. H04N 5/232

(52) U.S. Cl. CPC H04N 5/23219

(57) ABSTRACT

In some examples, an electronic device includes an image sensor to capture an image of a scene. In some examples, the electronic device includes a machine learning circuit to execute a machine learning model on the image of the scene to determine a shutter activation parameter. In some examples, the machine learning circuit is to activate a shutter of the image sensor in response to determining that the shutter activation parameter satisfies a condition.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a block diagram illustrating an example of an electronic device that may be used to provide shutter activation;

FIG. 2 is a diagram illustrating an example of a first image for which a shutter activation is not triggered in accordance with some of the techniques described herein;

FIG. 3 is a diagram illustrating an example of a second image for which a shutter activation is triggered in accordance with some of the techniques described herein;

FIG. 4 is a block diagram illustrating an example of an apparatus for shutter activation;

FIG. 5 is a flow diagram illustrating an example of shutter control;

FIG. 6 is a block diagram illustrating an example of a computer-readable medium for shutter activation; and

FIG. 7 is a diagram illustrating an example of a laptop computer that includes a machine learning circuit and a processor.

### DETAILED DESCRIPTION

Privacy issues may arise as people work from home and spend time in video calls (e.g., online meetings). For instance, a laptop camera may capture awkward moments as people move away from the camera. In some cases, a camera may be left on accidently, which can cause a privacy issue as personal areas of the home become work-from-home environments.

Some examples of the techniques described herein may provide approaches for shutter activation. A shutter may be a device to reduce or block image information. In some examples, a shutter may physically block a field of view of an image sensor, disable an image sensor, switch off an image sensor stream, substitute an image sensor stream, disable an aspect of image sensor operation, or perform a combination thereof.

Some examples of the techniques described herein may utilize machine learning. Machine learning may be a technique where a machine learning model may be trained to perform a task based on a set of examples (e.g., data). Training a machine learning model may include determining weights corresponding to structures of the machine learning model. In some examples, artificial neural networks may be a kind of machine learning model that may be structured with nodes, layers, connections, or a combination thereof.

Examples of neural networks may include convolutional neural networks (CNNs) (e.g., CNN, deconvolutional neural network, inception module, residual neural network, etc.) and recurrent neural networks (RNNs) (e.g., RNN, multi-layer RNN, bi-directional RNN, fused RNN, clockwork RNN, etc.). Different neural network depths may be utilized in accordance with some examples of the techniques described herein.

In some examples, the machine learning model(s) may be trained with a set of training images. For instance, a set of training images may include images of an object(s) for detection (e.g., images of a user, people, etc.). In some examples, the set of training images may be labeled with the class of object(s), location (e.g., bounding box) of object(s) in the images, or a combination thereof. The machine learning model(s) may be trained to detect the object(s) by iteratively adjusting weights of the model(s) and evaluating a loss function(s). The trained machine learning model may detect the object(s) (with a degree of probability, for instance). For example, a video stream may be utilized with computer vision techniques to detect an object(s) (e.g., a user, people, etc.).

Throughout the drawings, similar reference numbers may designate similar or identical elements. When an element is referred to without a reference number, this may refer to the element generally, with or without limitation to any particular drawing or figure. In some examples, the drawings are not to scale and the size of some parts may be exaggerated to more clearly illustrate the example shown. Moreover, the drawings provide examples in accordance with the description. However, the description is not limited to the examples provided in the drawings.

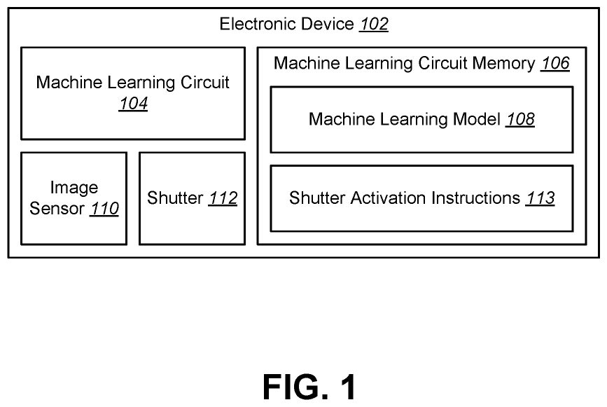

FIG. 1 is a block diagram illustrating an example of an electronic device 102 that may be used to provide shutter activation. An electronic device may be a device that includes electronic circuitry. Examples of the electronic device 102 may include a computer (e.g., laptop computer), a smartphone, a tablet computer, mobile device, camera, etc. In some examples, the electronic device 102 may include or may be coupled to a machine learning circuit 104, machine learning circuit memory 106, image sensor 110, shutter 112, or a combination thereof. In some examples, components of the electronic device 102 may be coupled via an interface(s) (e.g., bus(es), wire(s), connector(s), etc.). The electronic device 102 may include additional components (not shown) or some of the components described herein may be removed or modified without departing from the scope of this disclosure. In some examples, the electronic device 102 may include the image sensor 110 (e.g., an integrated camera). In some examples, the electronic device 102 may be in communication with a separate image sensor (e.g., camera). For instance, an image sensor (e.g., web cam, camera, millimeter wave sensor, time of flight (TOF) sensor, infrared (IR) sensor, depth sensor, radar, etc.) may be attached to the electronic device and may send an image(s) (e.g., video stream) to the electronic device 102. In some examples, an image may include visual information, depth information, IR sensing information, TOF information, or a combination thereof.

In some examples, the electronic device 102 may include a communication interface(s) (not shown in FIG. 1). The electronic device 102 may utilize the communication interface(s) to communicate with an external device(s) (e.g., networked device, server, smartphone, microphone, camera, printer, computer, keyboard, mouse, etc.). In some examples, the electronic device 102 may be in communication with (e.g., coupled to, have a communication link with) a display device(s). In some examples, the electronic device 102 may include an integrated display panel, touchscreen, button, microphone, or a combination thereof.

In some examples, the communication interface may include hardware, machine-readable instructions, or a combination thereof to enable a component (e.g., machine learning circuit 104, machine learning circuit memory 106, etc.) of the electronic device 102 to communicate with the external device(s). In some examples, the communication interface may enable a wired connection, wireless connection, or a combination thereof to the external device(s). In some examples, the communication interface may include a network interface card, may include hardware, may include machine-readable instructions, or may include a combination thereof to enable the electronic device 102 to communicate with an input device(s), an output device(s), or a combination thereof. Examples of output devices include a display device(s), speaker(s), headphone(s), etc. Examples of input devices include a keyboard, a mouse, a touchscreen, image sensor, microphone, etc. In some examples, a user may input instructions or data into the electronic device 102 using an input device(s).

In some examples, the communication interface(s) may include a mobile industry processor interface (MIPI), Universal Serial Bus (USB) interface, or a combination thereof. The image sensor 110 or a separate image sensor (e.g., webcam) may be utilized to capture and feed image(s) (e.g., a video stream) to the electronic device 102 (e.g., to the machine learning circuit 104 or the machine learning circuit memory 106). In some examples, the communication interface(s) (e.g., MIPI, USB interface, etc.) may be coupled to the machine learning circuit 104, to the machine learning circuit memory 106, or a combination thereof. The communication interface(s) may provide the image(s) to the machine learning circuit 104 or the machine learning circuit memory 106 from the separate image sensor.

The image sensor 110 may be a device to sense or capture image information (e.g., an image stream, video stream, etc.). Some examples of the image sensor 110 may include an optical (e.g., visible spectrum) image sensor, millimeter wave sensor, TOF sensor, red-green-blue (RGB) sensor, IR sensor, depth sensor, etc., or a combination thereof. For instance, the image sensor 110 may be a device to capture optical (e.g., visual) image data (e.g., a sequence of video frames).

The image sensor 110 may capture an image (e.g., series of images, video stream, etc.) of a scene. For instance, the image sensor 110 may capture video for a video conference, broadcast, recording, etc.

In some examples, the machine learning circuit memory 106 may be an electronic storage device, magnetic storage device, optical storage device, other physical storage device, or a combination thereof that contains or stores electronic information (e.g., instructions, data, or a combination thereof). In some examples, the machine learning circuit memory 106 may be, for example, Random Access Memory (RAM), Electrically Erasable Programmable Read-Only Memory (EEPROM), a storage device, an optical disc, the like, or a combination thereof. In some examples, the machine learning circuit memory 106 may be volatile or non-volatile memory, such as Dynamic Random Access Memory (DRAM), EEPROM, magnetoresistive random-access memory (MRAM), phase change RAM (PCRAM), memristor, flash memory, the like, or a combination thereof. In some examples, the machine learning circuit memory 106 may be a non-transitory tangible machine-readable or computer-readable storage medium, where the term “non-transitory” does not encompass transitory propagating signals. In some examples, the machine learning circuit memory 106 may include multiple devices (e.g., a RAM card and a solid-state drive (SSD)). In some examples, the machine learning circuit memory 106 may be integrated into the machine learning circuit 104. In some examples, the machine learning circuit memory 106 may include (e.g., store) a machine learning model 108, shutter activation instructions 113, or a combination thereof.

The machine learning circuit 104 may be electronic circuitry to process an image(s) (e.g., perform an operation on a video stream). In some examples, the machine learning circuit 104 may be logic circuitry to perform object detection, object tracking, feature point detection, motion estimation, attention detection, etc., or a combination thereof. In some examples, the machine learning circuit 104 may be a semiconductor-based microprocessor, field-programmable gate array (FPGA), an application-specific integrated circuit (ASIC), other hardware device, or a combination thereof suitable for retrieval and execution of instructions stored in the machine learning circuit memory 106. The machine learning circuit 104 may execute instructions stored in the machine learning circuit memory 106. In some examples, the machine learning circuit 104 may include electronic circuitry that includes electronic components for performing an operation or operations described herein without the machine learning circuit memory 106. In some examples, the machine learning circuit 104 may perform one, some, or all of the aspects, operations, elements, etc., described in one, some, or all of FIG. 1-7. In some examples, the machine learning circuit 104 may be artificial intelligence circuitry. In some examples, artificial intelligence circuitry may be circuitry to perform machine learning technique(s), learning technique(s), neural network technique(s), or a combination thereof.

In some examples, the machine learning circuit 104 may receive an image (e.g., image sensor stream, video stream, etc.). For instance, the machine learning circuit 104 may receive an image from the image sensor 110. In some examples, the machine learning circuit 104 may receive an image (e.g., image sensor stream, video stream, etc.) from a separate image sensor. For instance, the machine learning circuit 104 may receive an image stream via a wired or wireless communication interface (e.g., MIPI, USB port, Ethernet port, Bluetooth receiver, etc.).

In some examples, the electronic device 102 may include a processor. Some examples of the processor may include a general-purpose processor, central processing unit (CPU), a graphics processing unit (GPU), or a combination thereof. In some examples, the processor may be an application processor. In some examples, the processor may perform one, some, or all of the aspects, operations, elements, etc., described in one, some, or all of FIG. 1-7. In some examples, the processor may be coupled to the machine learning circuit 104. The processor may be separate from the machine learning circuit 104 in some examples. For instance, the machine learning circuit 104 may be separate circuitry or hardware from the processor (e.g., general-purpose processor or CPU of the electronic device 102). In some examples, the machine learning circuit 104 and the processor may be combined into one processor.

In some examples, the machine learning circuit 104 may be a processor (e.g., CPU, application processor, etc.) of the electronic device 102. In some examples, the machine learning circuit 104 may receive the image independently from (e.g., on a different path from, in parallel to, etc.) a processor (e.g., CPU) of the electronic device 102. In some examples, the image (e.g., video stream) may be carried on different links, connections, wires, interfaces, or a combination thereof to the machine learning circuit 104 and a processor (e.g., CPU, application processor, etc.). In some examples, the machine learning circuit 104 may receive the image (e.g., video stream) on a first path and a processor may receive the video stream on a second path, where the first path is shorter than the second path from the image sensor 110. For instance, the machine learning circuit 104 may be disposed physically closer to the image sensor 110 than a processor (e.g., CPU) of the electronic device 102. For example, the electronic device 102 may be a laptop computer, where the machine learning circuit 104 is disposed in a display panel housing of the laptop computer and a processor is disposed in a body of the laptop computer. The display panel housing may house the image sensor 110, resulting in the machine learning circuit 104 being disposed more closely to the image sensor 110 than a processor. For instance, the first path between the image sensor 110 and the machine learning circuit 104 may be disposed in the display panel housing, and the second path may cross a hinge of the laptop computer to the body of the computer to reach a processor. In some examples, the machine learning circuit 104 may experience less delay to receive the image (e.g., video stream) after capture than the image sensor 110.

In some examples, the machine learning circuit 104 may execute the machine learning model 108 on an image of a scene to determine a shutter activation parameter. A shutter activation parameter may be a value that may be utilized to determine whether to activate a shutter 112. For example, the machine learning circuit 104 may execute the machine learning model 108 on the image to infer a shutter activation parameter. Some examples of a shutter activation parameter may include a foreground presence parameter, a bounding box, an attention detection parameter, or a background activity parameter.

In some examples, the machine learning circuit 104 may activate a shutter 112 of the image sensor 110 in response to determining that the shutter activation parameter satisfies a condition. For instance, the machine learning circuit 104 may execute the shutter activation instructions 113 to determine whether the shutter activation parameter satisfies a condition. In a case that the shutter activation parameter satisfies a condition, the machine learning circuit 104 may activate the shutter 112. A condition may be a criterion that may be utilized to determine whether to activate the shutter 112. Examples of a condition may include a case when a person is not detected in the foreground region, a case when a size of a bounding box is less than a threshold size, a case when a lack of attention is detected, or when activity is occurring in a background region.

In some examples, the machine learning model 108 may be trained to detect a foreground presence based on the image. A foreground presence may be a situation where a person is located within a foreground region (e.g., within a distance of 3 feet, 5 feet, 6 feet, 10 feet, etc., from the image sensor 110). In some examples, the machine learning model 108 may be trained using training images that depict people in the foreground region (e.g., within the distance from the image sensor) and training images that depict people outside of the foreground region (e.g., greater than the distance from the image sensor). The training images may be labeled as being within the foreground region or outside of the foreground region. In some examples, the shutter activation parameter may be a foreground presence parameter indicating whether a person is detected in a foreground region relative to the image sensor. For instance, the machine learning circuit 104 may execute the machine learning model 108 to classify an image as depicting a person in a foreground region or not. In some examples, the condition may be satisfied when the foreground presence parameter indicates that a person is not detected in the foreground region. For instance, if the foreground presence parameter indicates that a person is not detected in the foreground region, the machine learning circuit 104 may activate the shutter 112.

In some examples, the machine learning model 108 may be trained to detect a bounding box based on the image. A bounding box is a region of an image that indicates a detected object (e.g., face, torso, body, etc.). For instance, a bounding box may be a rectangular region that spans the dimensions of a detected object. In some examples, the machine learning model 108 may be trained using training images that depict an object (e.g., face, torso, body, etc.) for detection. A training image may be labeled with a bounding box located around the object. In some examples, the shutter activation parameter may be a bounding box detected by the machine learning model 108. For instance, the machine learning circuit 104 may execute the machine learning model 108 to detect a bounding box of an object in the image. In some examples, the condition may be satisfied when a size of the bounding box is less than a threshold size. In some examples, a bounding box size may be calculated as an area, diagonal (e.g., corner-to-corner) length, average side length, height, width, perimeter length, or a combination thereof. For instance, the machine learning circuit 104 may calculate the size of a detected bounding box and compare the size of the bounding box to a threshold size. For instance, if the bounding box has a size that is less than a threshold size, the machine learning circuit 104 may activate the shutter 112. Examples of a threshold size may include 75,000 pixels (px) for bounding box area, 250 px for bounding box width, 350 px for bounding box diagonal length, etc. While some examples of threshold size are given, other values may be utilized in some examples. In some examples, threshold size may vary based on image resolution, foreground region size, received user settings, or a combination thereof.

In some examples, the machine learning model 108 may be trained to detect attention based on the image. Attention may be a situation where a person is paying attention (e.g., looking towards an image sensor, looking at a display panel located by the image sensor, etc.). In some examples, the machine learning model 108 may be trained using training images that depict people paying attention and training images that depict people that are not paying attention. The training images may be labeled as depicting people paying attention or not. In some examples, the shutter activation parameter may be an attention detection parameter. The attention detection parameter may indicate whether a person is detected as paying attention or not. For instance, the machine learning circuit 104 may execute the machine learning model 108 to classify an image as depicting a person paying attention or not. In some examples, the condition may be satisfied when the attention detection parameter indicates a lack of attention (e.g., that a person is not paying attention, that attention is not detected, etc.). For instance, if the attention detection parameter indicates that a person is not paying attention, the machine learning circuit 104 may activate the shutter 112.

In some examples, the machine learning model 108 may be trained to detect background activity based on the image. Background activity may be a situation where movement (e.g., a moving person, pet, etc.) is detected in a background region (e.g., in the field of view of the image sensor and beyond 3 feet, 5 feet, 6 feet, 10 feet, etc., from the image sensor 110). In some examples, the machine learning model 108 may be trained using training images that depict activity in the background region (e.g., activity beyond the distance from the image sensor) and training images that depict no activity in the background region. The training images may be labeled as including background activity or not including background activity. In some examples, the shutter activation parameter may be a background activity parameter indicating whether activity is occurring in a background region relative to the image sensor. For instance, the machine learning circuit 104 may execute the machine learning model 108 to classify an image as including background activity (e.g., motion) or not.

In some examples, the machine learning circuit 104 may detect or track a feature point or points of the background region to produce the background activity parameter. For instance, the machine learning circuit 104 may detect a feature point(s) (e.g., corner(s), edge(s), keypoint(s), etc.) associated with the background region in video frames. For instance, the machine learning circuit 104 may track the location of the feature point(s) in the video frames. In some examples, tracking the location of the feature point(s) may include matching a feature point (or patch including a feature point) in a first video frame to a feature point in a second video frame (e.g., subsequent video frame). For instance, the machine learning circuit 104 may extract pixel information of a feature point or patch including the feature point in a first video frame and correlate the patch with windows in the second video frame, where a greatest correlation may indicate the location of the corresponding feature point in the second video frame. A distance (e.g., pixel distance) or vector between the feature point in the first video frame and the corresponding feature point in the second video frame may indicate activity in the background region. For instance, if the distance is greater than a threshold distance, the machine learning circuit 104 may detect activity in the background region. In some examples, multiple feature points may be tracked and corresponding distances or vectors may be combined (e.g., averaged) to detect activity in the background region.

In some examples, the machine learning circuit 104 may perform optical flow to detect activity in the background region. For instance, the optical flow between two successive frames may be computed. Optical flow may be the motion of an object between frames (e.g., consecutive frames, successive frames, etc.) caused by the movement of the object. In some examples, computing the optical flow may include tracking a set of feature points between two frames, where the tracked set of feature points may enable estimating the motion between the frames. If the motion is greater than a motion threshold, the machine learning circuit 104 may detect activity in the background region.

In some examples, the machine learning circuit 104 may perform object detection and tracking to determine the background activity parameter. For instance, the machine learning circuit 104 may detect an object in a background region of a first frame and in the background region of a second frame. If a distance between the object (e.g., a bounding box of the object) in the first frame and the object (e.g., a bounding box of the object) in the second frame is greater than a distance threshold, the machine learning circuit 104 may detect activity in the background region.

In some examples, the condition may be satisfied when the background activity parameter indicates that activity is occurring in the background region. For instance, if the background activity parameter indicates that activity is detected in the background region, the machine learning circuit 104 may activate the shutter 112.

In some examples, the shutter 112 may be a mechanical shutter, an electronic shutter, or a combination thereof. For instance, a mechanical shutter may be a device (e.g., mechanically actuated device) that covers an image sensor lens or reduces (e.g., blocks) light from entering an image sensor. In some examples, an electronic shutter may be a device (e.g., circuitry) that disables an image sensor (e.g., switches power off to an image sensor), switches off an image stream (e.g., switches off an image sensor output or video stream), substitutes an image stream (e.g., inserts another image or video instead of a video stream from the image sensor), disables an aspect of image sensor operation (e.g., switches off visual image capture while allowing IR, depth, or TOF capture to continue), reduces or blocks light from reaching an image sensor (e.g., activates a panel with switchable opacity in front of the image sensor or camera lens to reduce or block light from the image sensor), floods the image sensor with light (e.g., excessive light) to saturate the image sensor (e.g., disable meaningful image capture), or a combination thereof. In some examples, switching off visual image capture while IR, depth, or TOF capture continues may allow inferencing to continue using non-visual data, which may allow the image sensor shutter to be deactivated when the condition(s) is not satisfied. In some examples, an image stream or video stream may be switched off from another processor, which may allow the machine learning circuit 104 to continue inferencing while the other processor (e.g., application processor) does not have access to the image stream or video stream. The image stream or video stream may be switched on (e.g., restored) when the condition(s) is not satisfied.

In some examples, the machine learning circuit 104 may activate the shutter 112 in response to determining that the shutter activation parameter satisfies a condition. In some examples, the machine learning circuit 104 may activate the shutter 112 if the foreground presence parameter indicates that a person is not detected in the foreground region, if a size of a bounding box is less than a threshold size, if the attention detection parameter indicates a lack of attention, if the background activity parameter indicates that activity (e.g., movement) is occurring in the background region, or if a combination thereof occurs.

In some examples, the machine learning circuit 104 may send a signal to activate the shutter 112 in response to determining that the condition is satisfied. In some examples, the signal may be a value, code, pattern, voltage, current, or combination thereof. In some examples, the machine learning circuit 104 may send the signal to the shutter 112. For instance, the machine learning circuit 104 may send the signal to the shutter 112 via a wire, bus, or interface (e.g., inter-integrated circuit (I2C) interface, general purpose input/output (GPIO) interface, etc.). In some examples, the machine learning circuit 104 may send a first signal indicating that the condition is satisfied to activate the shutter 112 or a second signal indicating that the condition is not satisfied to deactivate the shutter 112.

In some examples, the shutter 112 may replace the image (e.g., a portion of the video stream) with a substitute image(s) when activated. For instance, the shutter 112 may replace a portion of the video stream with substitute video when activated. In some examples, the replacement may be performed using a driver (e.g., camera driver). For example, the driver may replace a portion of the video stream with the substitute video. In some examples, the driver may alter the image (e.g., portion of the video stream) to replace the video stream with altered video (e.g., blurred video, pixelated video, distorted video, etc.). In some examples, a substitute image may be an image (e.g., static image or video frames) to replace the image or a portion of a video stream (e.g., a portion in time (some video frames), a spatial portion (a region of the video stream), or a combination thereof). The substitute image may be utilized while the shutter 112 is activated. For example, when the shutter 112 is activated, the shutter 112 may inject the substitute image or video (e.g., prerecorded image(s) or video) into a video stream. The substitute image or video may be provided to an application (e.g., video conference application, etc.) utilizing the image stream. For instance, the substitute image or video may be provided to Zoom, Microsoft Teams, Google Hangouts, etc.

In some examples, the electronic device may include an input interface to receive a deactivation indicator. In some examples, an input interface may receive a deactivation indicator (e.g., button press, tap, keystroke, speech input, detected motion, or a combination thereof). The deactivation indicator may indicate an instruction to deactivate the shutter 112. In some examples, an input from a user may deactivate the shutter 112, override automatic shutter activation, or a combination thereof. In some examples, the machine learning circuit 104 may deactivate the shutter 112 (e.g., enable an image stream) in response to the deactivation indicator. In some examples, shutter deactivation may be utilized in situations where a user is purposefully in a background region (e.g., when giving a demonstration, writing on a whiteboard, etc.) where the shutter activation may otherwise be triggered.

In some examples, a condition, a threshold, a machine learning model, or a combination thereof may be adjusted or retrained in response to an adjustment trigger. In some examples, an adjustment trigger may be a detected event to adjust a condition, threshold, a machine learning model, or a combination thereof. Examples of an adjustment trigger may include a deactivation frequency, a detected behavior frequency, or an adjustment indicator. For example, the electronic device 102 (e.g., machine learning circuit 104) may adjust a condition, may adjust a threshold, or may update training of a machine learning model in response to an adjustment trigger. The adjustment may change the condition(s) under which a shutter activation is triggered (e.g., may make a shutter activation more likely or less likely to occur).

A deactivation frequency may be a threshold for a frequency of deactivation indicators. Examples of a deactivation frequency may include 3 deactivation indicators per hour, 4 deactivation indicators per day, etc. For instance, the electronic device 102 may track a number of deactivation indicators occurring over time. In a case that the deactivation frequency is reached, the electronic device 102 may adjust or retrain a condition, a threshold, or a machine learning model. For example, if shutter deactivation (e.g., shutter bypass) is used often (e.g., at the deactivation frequency), the electronic device 102 may trigger an adjustment to a condition, threshold, or machine learning model. For instance, if the bounding box size threshold frequently causes a shutter activation because the bounding box size often falls below the threshold size, and the user frequently deactivates the shutter, the electronic device 102 (e.g., machine learning circuit 104) may reduce the threshold size to reduce shutter activation triggering frequency. In some examples, the threshold size may be reduced by 2%, 5%, 10%, 20%, or another amount.

A detected behavior frequency may be a threshold for a frequency of a detected user behavior. Examples of a detected behavior frequency may include 3 detected behaviors per hour, 4 detected behaviors per day, etc. For instance, the electronic device 102 may track a number of detected behaviors occurring over time. In a case that the detected behavior frequency is reached, the electronic device 102 may adjust or retrain a condition, a threshold, or a machine learning model. Examples of detected behaviors may include behaviors to deactivate a shutter or re-enable an image sensor (e.g., moving nearer to the image sensor within a period after shutter activation, looking back at the image sensor within a period after shutter activation, etc.). For example, if the shutter is often activated (due to a bounding box having a size smaller than the threshold size, for instance) and the user frequently follows the shutter activations by moving closer to the image sensor to re-enable the image sensor, the electronic device 102 may trigger an adjustment to a condition, threshold, or machine learning model. For instance, this scenario may indicate that the threshold size for the bounding box is too large for a specific user and that the threshold size may be reduced to accommodate a specific user's behavior. In some examples, the electronic device 102 (e.g., the machine learning circuit 104) may track a quantity of instances that the bounding box grows in size within a period after a shutter activation to re-enable an image sensor, and if a quantity of the user behavior meets the detected behavior frequency, the electronic device 102 (e.g., machine learning circuit 104) may reduce the threshold size to reduce shutter activation triggering frequency. In some examples, the threshold size may be reduced by 2%, 5%, 10%, 20%, or another amount.

An adjustment indicator may be an indicator received via an input device (e.g., from a user) indicating an adjustment to a shutter condition, threshold, or machine learning model. In some examples, the adjustment indicator may indicate whether to increase or decrease shutter activation. In response to the adjustment indicator, the electronic device 102 may adjust the shutter condition, threshold, or machine learning model to increase or decrease shutter activation in accordance with the adjustment indicator. For instance, a threshold size for a bounding box may be increased or reduced by 2%, 5%, 10%, 20%, or another amount.

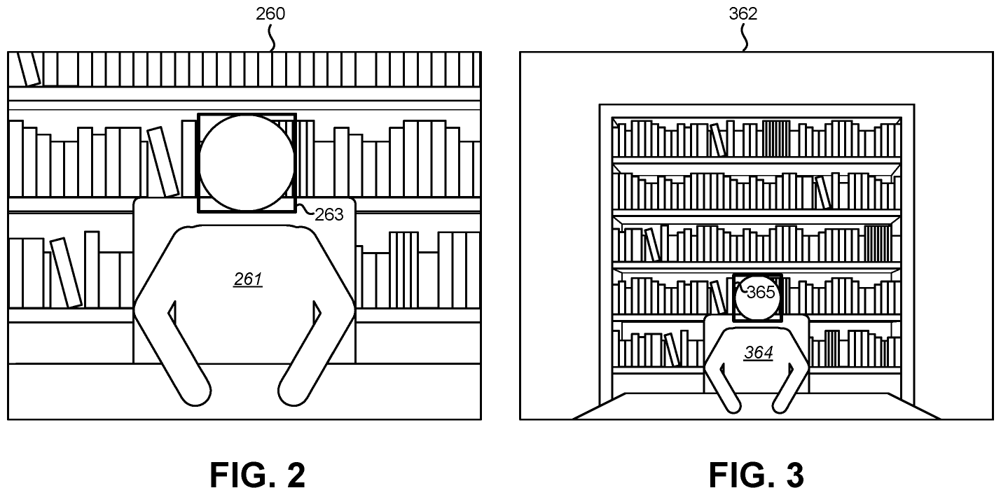

FIG. 2 is a diagram illustrating an example of a first image 260 for which a shutter activation is not triggered in accordance with some of the techniques described herein. FIG. 3 is a diagram illustrating an example of a second image 362 for which a shutter activation is triggered in accordance with some of the techniques described herein. FIG. 2 and FIG. 3 are described together.

As described in FIG. 1, a machine learning model may be trained to detect a foreground presence. For example, a machine learning model may be trained to recognize a situation where a person is situated within 5 feet of an image sensor. In the example of FIG. 2, a machine learning model may be executed on the first image 260 to infer that a first person 261 is located in a foreground region (e.g., is within five feet of an image sensor). For instance, the machine learning model may produce a foreground presence parameter indicating that the first person 261 is within the foreground region. In the example of FIG. 3, a machine learning model may be executed on the second image 362 to infer that no person is detected in a foreground region. For instance, while a second person 364 is depicted in the second image 362 (e.g., beyond five feet from an image sensor), the machine learning model may produce a foreground presence parameter indicating that no person is located or detected within the foreground region. The foreground presence parameter may trigger a shutter activation for the second image 362.

In some examples of the techniques described herein, a bounding box may be utilized to trigger shutter activation. In the first image 260, for instance, a machine learning model may be utilized to detect a first bounding box 263 around the face of the first person 261. The first bounding box 263 may have a size (e.g., 100,000 px) that is greater than a threshold size (e.g., 75,000 px), and not trigger shutter activation. In the second image 362, a machine learning model may be utilized to detect a second bounding box 365 around the face of the second person 364. The second bounding box 365 may have a size (e.g., 25,000 px) that is less than a threshold size (e.g., 75,000 px), and may trigger shutter activation. In a case where no bounding box is detected, a bounding box size of 0 px may be utilized, which may trigger shutter activation. For instance, a case of no bounding box (e.g., bounding box with a size of 0 px) may indicate that no person is present in a room, in which case shutter activation may be triggered.

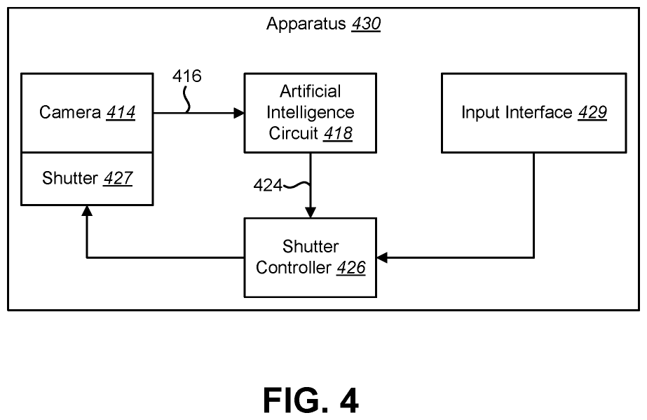

FIG. 4 is a block diagram illustrating an example of an apparatus 430 for shutter activation. In some examples, the apparatus 430 may perform an aspect or aspects of the operations described in FIG. 1, FIG. 2, FIG. 3, or a combination thereof. The apparatus 430 may be an example of the electronic device 102 described in FIG. 1. In some examples, the apparatus 430 may include a camera 414, artificial intelligence circuit 418, an input interface 429, a shutter controller 426, a shutter 427, or a combination thereof. Examples of the apparatus 430 may include a computing device, smartphone, laptop computer, tablet device, mobile device, etc.). In some examples, one, some, or all of the components of the apparatus 430 may be structured in hardware or circuitry. In some examples, the apparatus 430 may perform one, some, or all of the operations described in FIG. 1-7.

A camera 414 may capture a video stream 416. For instance, the video stream 416 may be captured at a frame rate and a resolution. In some examples, the video stream 416 may depict a scene. In some examples, the video stream 416 may depict a person in the scene or may depict a scene without a person. In some examples, the camera 414 may be an example of the image sensor 110 described in FIG. 1. The video stream 416 may be provided to the artificial intelligence circuit 418. In some examples, the video stream 416 may be provided to an application processor (e.g., CPU). In some examples, the artificial intelligence circuit 418 may be an example of the machine learning circuit 104 described in FIG. 1. In some examples, the machine learning circuit 104 described in FIG. 1 may be an example of the artificial intelligence circuit 418.

The artificial intelligence circuit 418 may determine a first inference indicating whether a user is located in a foreground region relative to the camera 414 based on the video stream. In some examples, the artificial intelligence circuit 418 may determine the first inference as described in FIG. 1. For example, the artificial intelligence circuit 418 may determine whether a person is detected in a foreground region relative to the camera 414 (e.g., may determine a foreground presence parameter). In some examples, the artificial intelligence circuit 418 may provide inference data 424 to the shutter controller 426. For instance, the shutter controller 426 may receive the inference data 424 via a bus, wire, internal interface (e.g., I2C interface), etc. In some examples, the artificial intelligence circuit 418 may provide the first inference (e.g., foreground presence parameter) to the shutter controller 426 in the inference data 424.

The artificial intelligence circuit 418 may determine a second inference indicating whether activity is occurring in a background region relative to the camera 414 based on the video stream. In some examples, the artificial intelligence circuit 418 may determine the second inference as described in FIG. 1. In some examples, the artificial intelligence circuit 418 may determine whether the video stream 416 depicts background activity (e.g., may determine a background activity parameter) by executing a machine learning model trained to detect background activity, by determining a feature point distance between frames and comparing the distance to a threshold distance, by performing optical flow in the background region to determine background motion and comparing the motion to a motion threshold, or by performing a combination thereof. In some examples, the background region of an image or video stream may be determined as a region that does not include a person in a foreground region. For instance, the background region may be a region outside of a detected bounding box for a head, torso, body, etc., of a person in the foreground region. In some examples, the background region of an image or video stream 416 may be determined as a region where a detected depth is greater than a depth threshold (e.g., 3 feet, 5 feet, 7 feet, 10 feet, etc.). For instance, the camera 414 may include depth sensing in some examples. In some examples, the camera 414 may include a red-green-blue-depth (RGB-D) sensor, TOF camera, or a combination thereof that may provide depth information. The background activity inferencing or detection may be performed on the background region of an image(s) (e.g., video stream frames) or on a whole image(s) (e.g., video stream frames). In some examples, the artificial intelligence circuit 418 may provide the second inference (e.g., background activity parameter) to the shutter controller 426 in the inference data 424.

The artificial intelligence circuit 418 may determine a third inference indicating a bounding box based on the video stream. In some examples, the artificial intelligence circuit 418 may determine the bounding box as described in FIG. 1. For example, the artificial intelligence circuit 418 may determine a position of a detected face, head, torso, or body of a person depicted in the video stream. In some examples, the artificial intelligence circuit 418 may provide the third inference (e.g., bounding box, bounding box position, bounding box dimensions, or a combination thereof) to the shutter controller 426 in the inference data 424.

The artificial intelligence circuit 418 may determine a fourth inference indicating whether user attention is detected based on the video stream. In some examples, the artificial intelligence circuit 418 may determine whether user attention is detected as described in FIG. 1. For example, the artificial intelligence circuit 418 may classify an image (e.g., frame of the video stream) as depicting a user as paying attention or not (e.g., may determine an attention detection parameter). In some examples, the artificial intelligence circuit 418 may provide the fourth inference (e.g., attention detection parameter) to the shutter controller 426 in the inference data 424.

In some examples, the shutter controller 426 may control a shutter 427 of the camera 414 based on the first inference, the second inference, the third inference, the fourth inference, or a combination thereof. In some examples, controlling the shutter 427 may be performed as described in FIG. 1. For instance, the shutter controller 426 may control the shutter 427 of the camera 414 based on the first inference and the second inference. For example, if the first inference indicates that a user is not present in the foreground region or if the second inference indicates that background activity is detected, the shutter controller 426 may activate the shutter 427.

In some examples, the shutter controller 426 may control the shutter 427 of the camera 414 based on the first inference, the second inference, the third inference, and the fourth inference. For example, if the first inference indicates that a user is not present in the foreground region, if the second inference indicates that background activity is detected, if the third inference indicates a bounding box that is less than a threshold size, or if the fourth inference indicates that a user is not paying attention, the shutter controller 426 may activate the shutter 427. In some examples, the shutter controller 426 may deactivate the shutter 427 if no condition is satisfied. For example, if the first inference indicates that a user is present in the foreground region, if the second inference indicates that background activity is not detected, if the third inference indicates a bounding box that is greater than or equal to a threshold size, and if the fourth inference indicates that a user is paying attention, the shutter controller 426 may deactivate the shutter 427. In some examples, the shutter controller 426 may utilize any individual inference or combination of inferences to control the shutter 427.

The shutter 427 may be an example of the shutter 112 described in FIG. 1. In some examples, the shutter 427 may be a mechanical shutter, an electronic shutter, or a combination thereof. In some examples, the shutter controller 426 may activate or deactivate the shutter 427. In some examples, the shutter controller 426 may activate the shutter 427 to cover a camera lens, disable the camera 414, switch off the video stream 416 (e.g., block the video stream 416 from an application processor or CPU), substitute the video stream 416 with another image or video, disable an aspect of camera 414 operation, reduce or block light from reaching an image sensor, or a combination thereof.

In some examples, the shutter 427 may modify the video in response to shutter activation. For instance, the shutter 427 may replace a portion of the video stream 416 with substitute video. In some examples, the shutter 427 may modify video as described in FIG. 1. In some examples, the shutter 427 may replace a portion of the video stream 416 with prerecorded video, with a static image, with an animated avatar, or with a combination thereof.

In some examples, the apparatus 430 may include an input interface 429. The input interface 429 may receive a deactivation indicator. For instance, the input interface may receive a deactivation indicator as described in FIG. 1. The deactivation indicator may be provided to the shutter controller 426. In some examples, the shutter controller 426 may deactivate the shutter 427 (e.g., open the shutter, enable an image stream, etc.) of the camera 414 in response to the deactivation indicator. In some examples, the shutter controller 426, the artificial intelligence circuit 418, or a combination thereof may suspend determining an inference(s) or suspend determining whether to activate the shutter 427 in response to the deactivation indicator. The suspension may occur until a reset event is detected (e.g., apparatus 430 reboot, resume indicator received by the input interface 429, an application that uses the camera 414 is subsequently opened, etc. or a combination thereof).

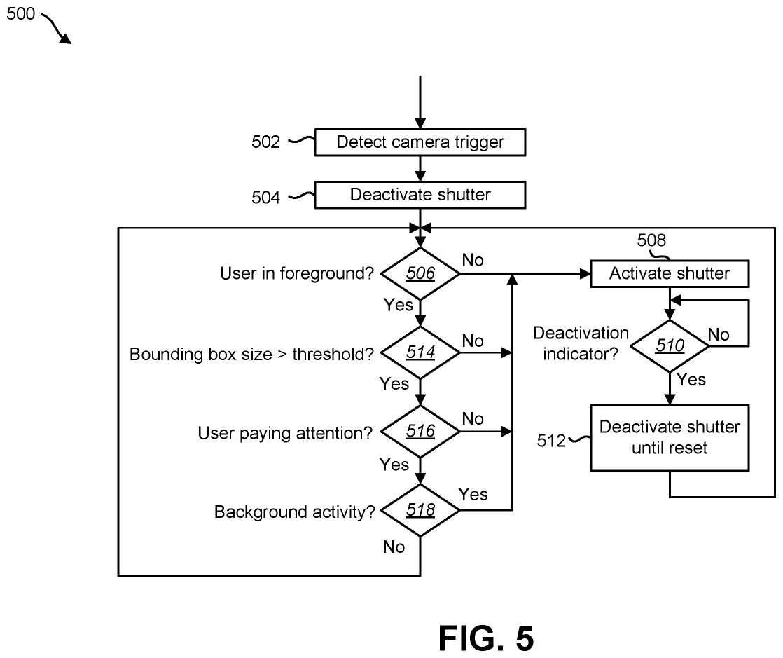

FIG. 5 is a flow diagram illustrating an example of shutter control. In some examples, the method 500 or a method 500 element(s) may be performed by an electronic device or apparatus (e.g., electronic device 102, apparatus 430, laptop computer, smartphone, tablet device, etc.). For example, the method 500 may be performed by the electronic device 102 described in FIG. 1 or the apparatus 430 described in FIG. 4.

At 502, an apparatus may detect a camera trigger. A camera trigger may be an event or request to utilize a camera. In some examples, an application may be executed that requests or accesses the camera, a button may be pressed to utilize the camera, an instruction may be received to access the camera, or a combination thereof.

At 504, the apparatus deactivates the shutter. In some examples, deactivating the shutter may including uncovering a camera lens, increasing light entering the camera, enabling a camera (e.g., switches power on to a camera), switching on an image stream (e.g., switching on a camera output or video stream), removing an image stream substitute, enabling an aspect of camera operation (e.g., switching on visual image capture), increasing or unblocking light from reaching an image sensor (e.g., deactivating a panel with switchable opacity in front of the image sensor or camera lens to increase or unblock light from the image sensor), or a combination thereof.

At 506, the apparatus may determine whether a user is detected in a foreground region. In some examples, detecting whether a user break is in a foreground region may be performed as described in FIG. 1, FIG. 2, FIG. 3, FIG. 4, or a combination thereof.

In a case that the apparatus determines that a user is not detected in a foreground region, the apparatus may activate a shutter at 508. In some examples, activating a shutter may be performed as described in FIG. 1, FIG. 4, or a combination thereof.

At 510, the apparatus may determine whether a deactivation indicator is received. In some examples, determining whether a deactivation indicator is received may be performed as described in FIG. 1, FIG. 4, or a combination thereof.

In a case that the apparatus determines that a deactivation indicator is not received, operation may return to determining whether a deactivation indicator is received at 510 (at a subsequent time, for instance). For instance, the shutter may continue to operate in an active state.

In a case that the apparatus determines that a deactivation indicator has been received, the apparatus may deactivate the shutter until reset at 512. In some examples, deactivating the shutter until reset may be performed as described in FIG. 1, FIG. 4, or a combination thereof. In some examples, the apparatus may suspend shutter activation, may suspend determining whether to activate the shutter, or a combination thereof until a reset event is detected (e.g., apparatus reboots, a resume indicator is received, an application that uses the camera is opened, etc. or a combination thereof). Operation may return to determining whether a user is detected in a foreground region at 506.

In a case that a user is detected in a foreground region at 506, the apparatus may determine whether a bounding box size is greater than a threshold size at 514. In some examples, determining whether a bounding box size is greater than a threshold size may be performed as described in FIG. 1, FIG. 2, FIG. 3, FIG. 4, or a combination thereof. In a case that the bounding box size is not greater than the threshold size, the apparatus may proceed to activate 508 the shutter as described and so on.

In a case that the bounding box size is greater than the threshold size, the apparatus may determine whether a user is paying attention at 516. In some examples, determining whether a user is paying attention may be performed as described in FIG. 1, FIG. 4, or a combination thereof. In a case that the apparatus determines that a user is not paying attention, the apparatus may proceed to activate 508 the shutter as described and so on.

In a case that the apparatus determines that a user is paying attention, the apparatus may determine whether background activity is detected at 518. In some examples, determining whether background activity is detected may be performed as described in FIG. 1, FIG. 4, or a combination thereof. In a case that the apparatus determines that background activity is detected, the apparatus may proceed to activate 508 the shutter as described and so on. In a case that the apparatus determines that background activity is not detected, operation may return to determining whether a user is in a foreground region at 506. For example, the apparatus may continue monitoring to determine whether to activate a shutter.

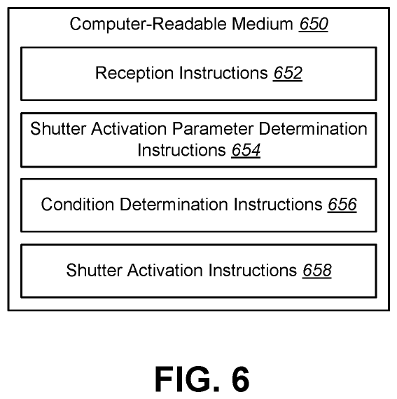

FIG. 6 is a block diagram illustrating an example of a computer-readable medium 650 for shutter activation. The computer-readable medium 650 is a non-transitory, tangible computer-readable medium. In some examples, the computer-readable medium 650 may be, for example, RAM, DRAM, EEPROM, MRAM, PCRAM, a storage device, an optical disc, the like, or a combination thereof. In some examples, the computer-readable medium 650 may be volatile memory, non-volatile memory, or a combination thereof. In some examples, the computer-readable medium 650 described in FIG. 6 may be an example of the machine learning circuit memory 106 described in FIG. 1.

The computer-readable medium 650 may include code (e.g., data, instructions). In some examples, the computer-readable medium 650 may include reception instructions 652, shutter activation parameter determination instructions 654, condition determination instructions 656, shutter activation instructions 658, or a combination thereof.

The reception instructions 652 may include instructions when executed cause a processor of an electronic device to receive a video stream from an image sensor. In some examples, receiving a video stream may be performed as described in FIG. 1, FIG. 4, or a combination thereof.

The shutter activation parameter determination instructions 654 may include instructions when executed cause the processor to determine, using a machine learning model, a shutter activation parameter based on the video stream. In some examples, determining a shutter activation parameter may be performed as described in FIG. 1, FIG. 2, FIG. 3, FIG. 4, FIG. 5, or a combination thereof.

The condition determination instructions 656 may include instructions when executed cause the processor to produce a determination that the shutter activation parameter satisfies a condition. In some examples, determining that the shutter activation parameter satisfies a condition may be performed as described in FIG. 1, FIG. 2, FIG. 3, FIG. 4, FIG. 5, or a combination thereof.

The shutter activation instructions 658 may include instructions when executed cause the processor to activate a shutter of the image sensor in response to the determination. In some examples, activating the shutter may be performed as described in FIG. 1, FIG. 3, FIG. 4, FIG. 5, or a combination thereof.

In some examples, the shutter may be an electronic shutter, a mechanical shutter, or a combination thereof. In some examples, the processor may activate an electronic shutter by switching the video stream. For example, the processor may turn the video stream off (e.g., switch off an interface of the video stream).

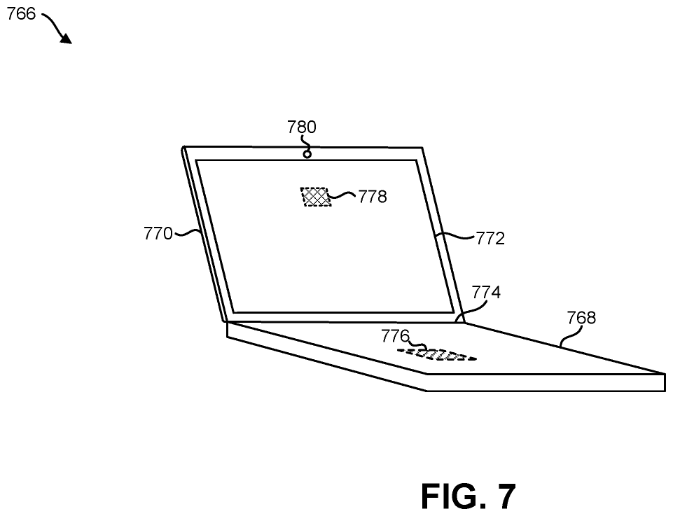

FIG. 7 is a diagram illustrating an example of a laptop computer 766 that includes a machine learning circuit 778 and a processor 776. In some examples, the laptop computer 766 may be an example of the electronic device 102 described in FIG. 1 or the apparatus 430 described in FIG. 4. In this example, the laptop computer 766 includes a body 768 and a display panel housing 770. In some examples, the display panel housing 770 may be rotatably coupled to the body 768 with a hinge 774, which may allow the display panel housing 770 to rotate into contact with the body 768 when closing the laptop computer 766.

The body 768 may house a component(s). For example, the body 768 may house a processor 776. The processor 776 may be a CPU or application processor. Examples of other components that may be housed in the body 768 may include memory or storage (e.g., RAM, solid state drive (SSD), etc.), a keyboard, motherboard, port(s), etc.

The display panel housing 770 may house a component(s). For example, the display panel housing 770 may house a display panel 772, a machine learning circuit 778, and a camera 780. The camera 780 may be coupled to the machine learning circuit 778 on a first path (e.g., first electronic link) and may be coupled to the processor 776 on a second path (e.g., second electronic link). In some examples, the first path is shorter than the second path. For example, the machine learning circuit 778 may be disposed more closely to the camera 780 than the processor 776. The machine learning circuit 778 may be able to receive a video stream from the camera 780 with less delay than the processor 776. This arrangement may help the machine learning circuit 778 perform inferencing with less delay than if a machine learning circuit were similarly situated with a processor. For instance, the machine learning circuit 778 may receive a video stream before the processor 776 and may determine a shutter activation parameter(s) with reduced delay in some examples of the techniques described herein.

In some examples, the machine learning circuit 778 may receive a video stream from the camera 780. For instance, the camera 780 may send video frames to the machine learning circuit 778. In some examples, the machine learning circuit 778 may utilize a CNN to perform computer vision operations. When the machine learning circuit 778 detects that a user is not in a foreground region, that a size of a bounding box is less than a size threshold, that a user is not paying attention, or that background activity is occurring, a shutter of the camera 780 may be activated.

As used herein, items described with the term “or a combination thereof” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

What is claimed is:

1. An electronic device, comprising:
an image sensor to capture an image of a scene; and
a machine learning circuit to:
execute a machine learning model on the image of the scene to determine a shutter activation parameter; and
activate a shutter of the image sensor in response to determining that the shutter activation parameter satisfies a condition.

2. The electronic device of claim 1, wherein the shutter activation parameter is a foreground presence parameter indicating whether a person is detected in a foreground region relative to the image sensor.

3. The electronic device of claim 2, wherein the condition is satisfied when the foreground presence parameter indicates that a person is not detected in the foreground region.

4. The electronic device of claim 1, wherein the shutter activation parameter is a bounding box detected by the machine learning model.

5. The electronic device of claim 4, wherein the condition is satisfied when a size of the bounding box is less than a threshold size.

6. The electronic device of claim 1, wherein the shutter activation parameter is an attention detection parameter.

7. The electronic device of claim 6, wherein the condition is satisfied when the attention detection parameter indicates a lack of attention.

8. The electronic device of claim 1, wherein the shutter activation parameter is a background activity parameter indicating whether activity is occurring in a background region relative to the image sensor, and wherein the condition is satisfied when the background activity parameter indicates that activity is occurring in the background region.

9. The electronic device of claim 1, wherein the machine learning circuit is to adjust a condition in response to an adjustment trigger.

10. An apparatus, comprising:
a camera to capture a video stream;
an artificial intelligence circuit to:
determine a first inference indicating whether a user is located in a foreground region relative to the camera based on the video stream; and
determine a second inference indicating whether activity is occurring in a background region relative to the camera based on the video stream; and
a shutter controller to control a shutter of the camera based on the first inference and the second inference.

11. The apparatus of claim 10, wherein the artificial intelligence circuit is to determine a third inference indicating a bounding box and is to determine a fourth inference indicating whether user attention is detected, and wherein the shutter controller is to control the shutter of the camera based on the first inference, the second inference, the third inference, and the fourth inference.

12. The apparatus of claim 10, further comprising an input interface to receive a deactivation indicator, wherein the shutter controller is to deactivate the shutter of the camera in response to the deactivation indicator.

13. A non-transitory tangible computer-readable medium comprising instructions when executed cause a processor of an electronic device to:
receive a video stream from an image sensor;
determine, using a machine learning model, a shutter activation parameter based on the video stream;
produce a determination that the shutter activation parameter satisfies a condition; and
activate a shutter of the image sensor in response to the determination.

14. The non-transitory tangible computer-readable medium of claim 13, wherein the shutter is an electronic shutter.

15. The non-transitory tangible computer-readable medium of claim 14, wherein the processor is to activate the electronic shutter by switching the video stream.
